(19) United States
(12) Patent Application Publication
(10) Pub. No.: US 2011/0049974 A1
(43) Pub. Date: Mar. 3, 2011

(54) METHODS AND SYSTEMS FOR BRAKING DIFFERENT AXLES OF A VEHICLE USING A DECELERATION VALUE

(75) Inventors: DANNY Y. MUI, BIRMINGHAM, MI (US); PATRICK J. MONSERE, HIGHLAND, MI (US); JON K. LOGAN, HOWELL, MI (US); MARGARET C. RICHARDS, ROYAL OAK, MI (US); ERIC E. KRUEGER, CHELSEA, MI (US); KEVIN S. KIDSTON, NEW HUDSON, MI (US); MATTHEW M. KARABA, OXFORD, MI (US)

(73) Assignee: GM GLOBAL TECHNOLOGY OPERATIONS, INC., DETROIT, MI (US)

(21) Appl. No.: 12/550,739

(22) Filed: Aug. 31, 2009

(51) Int. Cl. B60T 8/64

(52) U.S. Cl. 303/152

(57) ABSTRACT

A method for controlling braking of a vehicle having a first axle and a second axle includes the steps of obtaining a deceleration value pertaining to an input from a driver of the vehicle, braking the first axle with a first pressure, braking the second axle with a second pressure that is substantially equal to the first pressure if the deceleration value has not exceeded a predetermined threshold, and braking the second axle with a third pressure that is greater than the first pressure if the deceleration value has exceeded the predetermined threshold.

### TECHNICAL FIELD

The present invention generally relates to the field of vehicles and, more specifically, to methods and systems for controlling braking of vehicles.

### BACKGROUND OF THE INVENTION

Automobiles and various other vehicles include braking systems for reducing vehicle speed or bringing the vehicle to a stop. Such braking systems generally include a controller that provides braking pressure to braking calipers on one or both axles of the vehicle to produce braking torque for the vehicle. For example, in a regenerative braking system, a relatively greater amount of hydraulic or other braking pressure is generally provided for a non-regenerative braking axle, while a relatively lesser amount (if any) of hydraulic or other braking pressure is generally provided for a regenerative braking axle. However, in certain situations, for example when there is a pressure change in the regenerative axle results in fluctuations in boost pressure, a less than ideal driving experience, for example with non-linear decelerations, can result.

Accordingly, it is desirable to provide an improved method for controlling braking for a vehicle that provides braking pressure to different axles of the vehicle, such as a regenerative braking axles and a non-regenerative braking axle, in an improved manner. It is also desirable to provide an improved system for such controlling of braking for a vehicle that provides braking pressure to different axles of the vehicle in an improved manner. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for controlling braking of a vehicle having a first axle and a second axle is provided. The method comprises the steps of obtaining a deceleration value pertaining to an input from a driver of the vehicle, braking the first axle with a first pressure, braking the second axle with a second pressure that is substantially equal to the first pressure if the deceleration value has not exceeded a predetermined threshold, and braking the second axle with a third pressure that is greater than the first pressure if the deceleration value has exceeded the predetermined threshold.

In accordance with another exemplary embodiment of the present invention, a method for controlling braking of a vehicle having a regenerative braking axle and a non-regenerative braking axle is provided. The method comprises the steps of obtaining a deceleration value pertaining to an input from a driver of the vehicle, braking the regenerative braking axle and the non-regenerative braking axle using single channel blending provided that the deceleration value is less than or equal to a predetermined threshold, and braking the regenerative braking axle and the non-regenerative braking axle using dual channel blending if the deceleration value is greater than the predetermined threshold.

In accordance with a further exemplary embodiment of the present invention, a system for controlling braking of a vehicle having a regenerative braking axle and a non-regenerative braking axle is provided. The system comprises a sensor and a processor. The sensor is configured to detect a request corresponding to a requested braking torque. The processor is coupled to the sensor. The processor is configured to facilitate determining a deceleration pertaining to the vehicle based on the requested braking torque, braking the regenerative braking axle and the non-regenerative braking axle using single channel blending provided that the deceleration value is less than or equal to a predetermined threshold, and braking the regenerative braking axle and the non-regenerative braking axle using dual channel blending if the deceleration value is greater than the predetermined threshold.

### BRIEF DESCRIPTION OF THE DRAWINGS

The present invention will hereinafter be described in conjunction with the following drawing figures, wherein like numerals denote like elements, and wherein:

FIG. 1 is a functional block diagram of a braking system for a vehicle, such as an automobile, in accordance with an exemplary embodiment of the present invention;

FIG. 2 is a flowchart of a process for controlling braking and for apportioning braking pressure to different axles of the vehicle in a vehicle, such as an automobile, and that can be utilized in connection with the brake controller of FIG. 1, in accordance with an exemplary embodiment of the present invention; and

FIG. 3 is a depiction of exemplary graphical representation of various parameters pertaining to the brake controller of FIG. 1 and the process of FIG. 2 for an exemplary scenario in which the vehicle is being operated, in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

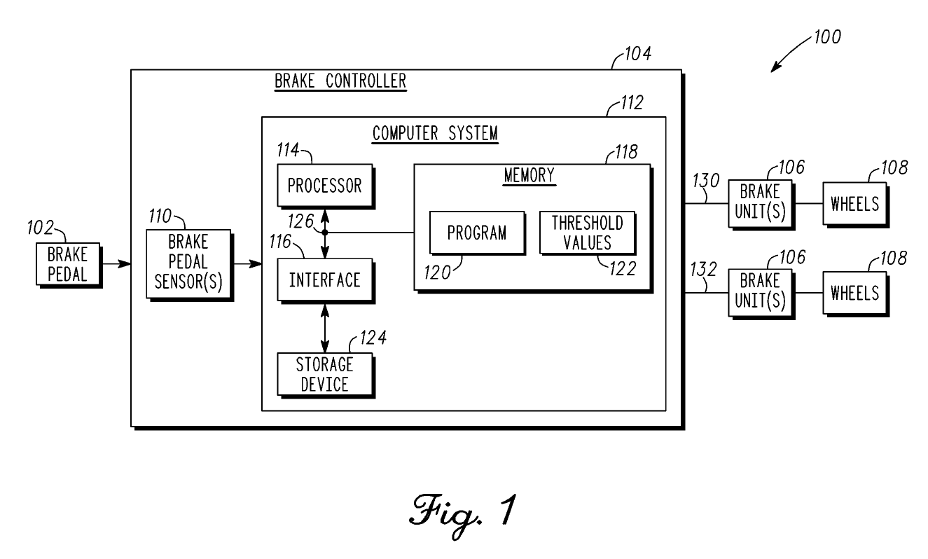

FIG. 1 is a block diagram of an exemplary braking system 100 for use in a brake-by-wire system of vehicle, such as an automobile. In a preferred embodiment, the vehicle comprises an automobile, such as a sedan, a sport utility vehicle, a van, or a truck. However, the type of vehicle may vary in different embodiments of the present invention.

As depicted in FIG. 1, the braking system 100 includes a brake pedal 102, a brake controller 104, and a plurality of brake units 106. The braking system 100 is used in connection with a first axle 130 and a second axle 132. Each of the first and second axles 130, 132 has one or more wheels 108 of the vehicle disposed thereon. Certain of the brake units 106 are disposed along a first axle 130 of the vehicle along with certain of the wheels 108, and certain other of the brake units 106 are disposed along a second axle 132 of the vehicle along with certain other of the wheels 108. In a preferred embodiment, the first axle 130 is a regenerative braking axle, and the second axle 132 is a non-regenerative braking axle 132. Also in one preferred embodiment, the first axle 130 comprises a front axle, and the second axle 132 comprises a rear axle.

The brake pedal 102 provides an interface between an operator of a vehicle and a braking system or a portion thereof, such as the braking system 100, which is used to slow or stop the vehicle. To initiate the braking system 100, an operator would typically use his or her foot to apply a force to the brake pedal 102 to move the brake pedal 102 in a generally downward direction. In one preferred embodiment the braking system 100 is an electro-hydraulic system. In another preferred embodiment, the braking system 100 is a hydraulic system.

The brake controller 104 is coupled between the brake pedal 102 and the brake units 106, and the first and second axles 130, 132. Specifically, the brake controller 104 monitors the driver's engagement of the brake pedal 102 and controls braking of the vehicle to apply appropriate amounts of braking pressure to the first axle 130 and to the second axle 132 of the braking system 100 via braking commends sent to the brake units 106 by the brake controller 104 along the first and second axles 130, 132.

In the depicted embodiment, the brake controller 104 comprises one or more brake pedal sensors 110 and a computer system 112. In certain embodiments, the brake controller 104 may be separate from the brake pedal sensors 110, among other possible variations. In addition, it will be appreciated that the brake controller 104 may otherwise differ from the embodiment depicted in FIG. 1, for example in that the brake controller 104 may be coupled to or may otherwise utilize one or more remote computer systems and/or other control systems.

The brake pedal sensors 110 are coupled between the brake pedal 102 and the computer system 112. Specifically, in accordance with various preferred embodiments, the brake pedal sensors 110 preferably include one or more brake pedal force sensors and/or one or more brake pedal travel sensors. The number of brake pedal sensors 110 may vary. For example, in certain embodiments, the brake controller 104 may include a single brake pedal sensor 110. In various other embodiments, the brake controller 104 may include any number of brake pedal sensors 110.

The brake pedal travel sensors, if any, of the brake pedal sensors 110 provide an indication of how far the brake pedal 102 has traveled, which is also known as brake pedal travel, when the operator applies force to the brake pedal 102. In one exemplary embodiment, brake pedal travel can be determined by how far an input rod in a brake master cylinder has moved.

The brake pedal force sensors, if any, of the brake pedal sensors 110 determine how much force the operator of braking system 100 is applying to the brake pedal 102, which is also known as brake pedal force. In one exemplary embodiment, such a brake pedal force sensor, if any, may include a hydraulic pressure emulator and/or a pressure transducer, and the brake pedal force can be determined by measuring hydraulic pressure in a master cylinder of the braking system 100.

Regardless of the particular types of brake pedal sensors 110, the brake pedal sensors 110 detect one or more values (such as brake pedal travel and/or brake pedal force) pertaining to the drivers' engagement of the brake pedal 102. The brake pedal sensors 110 also provide signals or information pertaining to the detected values pertaining to the driver's engagement of the brake pedal 102 to the computer system 112 for processing by the computer system 112.

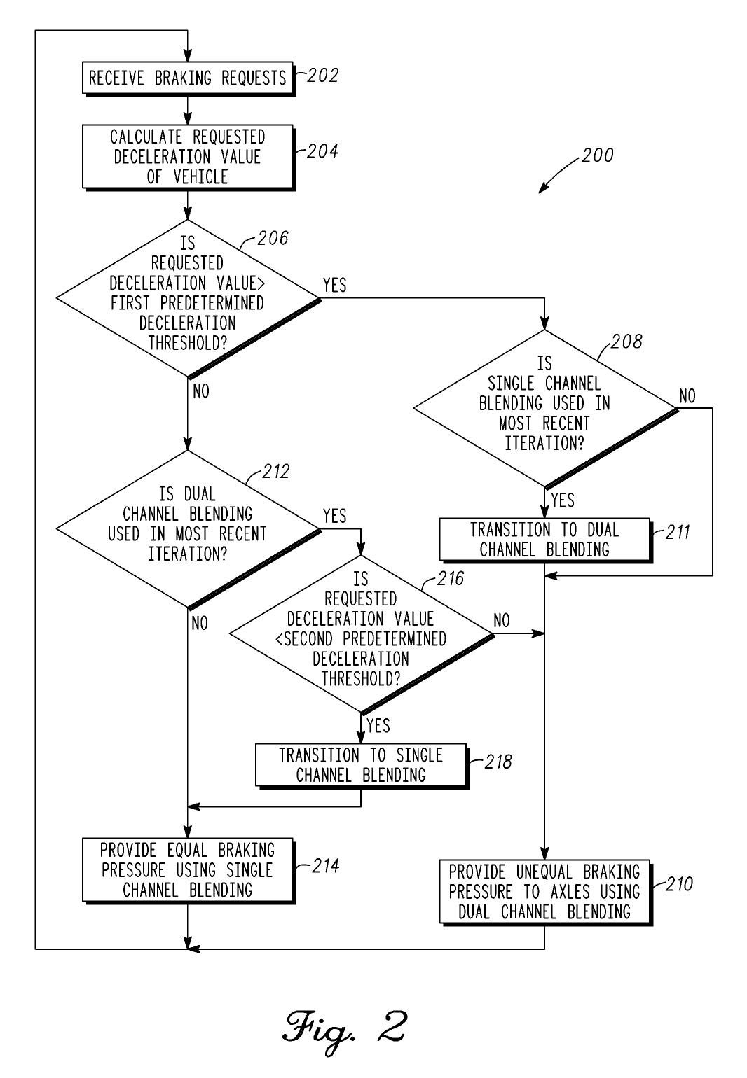

In the depicted embodiment, the computer system 112 is coupled between the brake pedal sensors 110, the brake units 106, and the first and second axles 130, 132. The computer system 112 receives the signals or information pertaining to the drivers' engagement of the brake pedal 102 from the brake pedal sensors 110. The computer system 112 further processes these signals or information in order to control braking of the vehicle and apply appropriate amounts of braking pressure to the first axle 130 and to the second axle 132 of the braking system 100 via braking commends sent to the brake units 106 by the computer system 112 along the first and second axles 130, 132, for improved braking performance and/or an improved experience for the driver of the vehicle. In a preferred embodiment, these and other steps are conducted in accordance with the process 200 depicted in FIG. 2 and described further below in connection therewith.

In the depicted embodiment, the computer system 112 includes a processor 114, a memory 118, an interface 116, a storage device 124, and a bus 126. The processor 114 performs the computation and control functions of the computer system 112 and the brake controller 104, and may comprise any type of processor or multiple processors, single integrated circuits such as a microprocessor, or any suitable number of integrated circuit devices and/or circuit boards working in cooperation to accomplish the functions of a processing unit. During operation, the processor 114 executes one or more programs 120 contained within the memory 118 and, as such, controls the general operation of the brake controller 104 and the computer system 112.

The memory 118 can be any type of suitable memory. This would include the various types of dynamic random access memory (DRAM) such as SDRAM, the various types of static RAM (SRAM), and the various types of non-volatile memory (PROM, EPROM, and flash). The bus 126 serves to transmit programs, data, status and other information or signals between the various components of the computer system 112. In a preferred embodiment, the memory 118 stores the above-referenced program 120 along with various threshold values 122 that are used in controlling the braking and apportioning braking pressure to the first and second axles 130, 132 in accordance with steps of the process 200 depicted in FIG. 2 and described further below in connection therewith.

The interface 116 allows communication to the computer system 112, for example from a system driver and/or another computer system, and can be implemented using any suitable method and apparatus. It can include one or more network interfaces to communicate with other systems or components. The interface 116 may also include one or more network interfaces to communicate with technicians, and/or one or more storage interfaces to connect to storage apparatuses, such as the storage device 124.

The storage device 124 can be any suitable type of storage apparatus, including direct access storage devices such as hard disk drives, flash systems, floppy disk drives and optical disk drives. In one exemplary embodiment, the storage device 124 comprises a program product from which memory 118 can receive a program 120 that executes one or more embodiments of one or more processes of the present invention, such as the process 200 of FIG. 2 or portions thereof. In another exemplary embodiment, the program product may be directly stored in and/or otherwise accessed by the memory 118 and/or a disk such as that referenced below.

The bus 126 can be any suitable physical or logical means of connecting computer systems and components. This includes, but is not limited to, direct hard-wired connections, fiber optics, infrared and wireless bus technologies. During operation, the program 120 is stored in the memory 118 and executed by the processor 114.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 112 may also otherwise differ from the embodiment depicted in FIG. 1, for example in that the computer system 112 may be coupled to or may otherwise utilize one or more remote computer systems and/or other control systems.

The brake units 106 are coupled between the brake controller 104 and the wheels 108. In the depicted embodiment, the brake units 106 are disposed along the first axle 130 and are coupled to certain wheels 108 on the first axle 130, and other of the brake units 106 are disposed along the second axle 132 and are coupled to other wheels of the second axle 132. The brake units 106 receive the braking commands from the brake controller 104, and are controlled thereby accordingly.

The brake units 106 can include any number of different types of devices that, upon receipt of braking commands, can apply the proper braking torque as received from the brake controller 104. For example, in an electro-hydraulic system, the brake units 106 can comprise an actuator that can generate hydraulic pressure that can cause brake calipers to be applied to a brake disk to induce friction to stop a vehicle. Alternatively, in an electro-mechanical brake-by-wire system, the brake units 106 can comprise a wheel torque-generating device that operates as a vehicle brake. The brake units 106 can also be regenerative braking devices, in which case the brake units 106, when applied, at least facilitate conversion of kinetic energy into electrical energy.

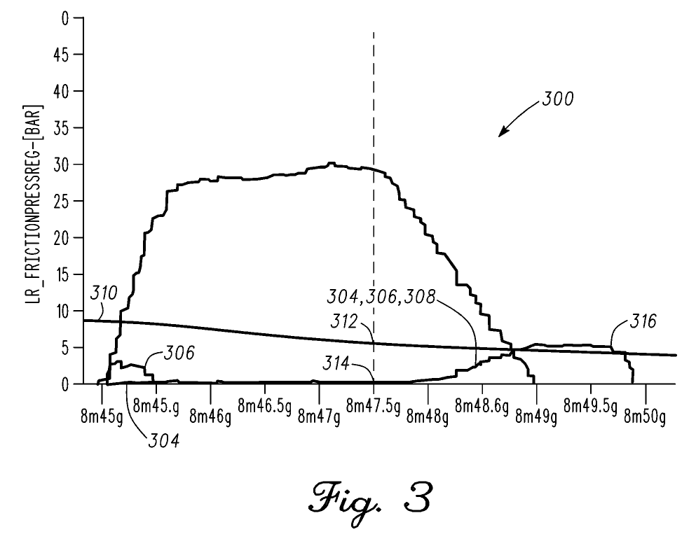

FIG. 2 is a flowchart of a process 200 for controlling braking in a vehicle and for apportioning braking pressure to different axles of the vehicle, in accordance with an exemplary embodiment of the present invention. The process 200 can be implemented in connection with the braking system 100 of FIG. 1, the brake controller 104 and/or the computer system 112 of FIG. 1, and/or program products utilized therewith, in accordance with an exemplary embodiment of the present invention. The process 200 will also be described below in connection with FIG. 3, which depicts a graphical representation 300 of various parameters pertaining to the process 200 in accordance with one exemplary embodiment of the present invention and with operation of the vehicle in one exemplary scenario.

As depicted in FIG. 2, the process 200 begins with the step of receiving one or more braking requests (step 202). The braking requests preferably pertain to values pertaining to engagement of the brake pedal 102 by a driver of the vehicle. In certain preferred embodiment, the braking requests pertain to values of brake pedal travel and/or brake pedal force as obtained by the brake pedal sensors 110 of FIG. 1 and provided to the computer system 112 of FIG. 1. Also in a preferred embodiment, the braking requests are received and obtained, preferably continually, at different points or periods in time throughout a braking event for the vehicle.

A requested deceleration value is calculated (step 204). The requested deceleration value preferably corresponds to a measure of deceleration of the vehicle corresponding to the braking request received or obtained during step 202 above. Specifically, in one preferred embodiment, the requested deceleration value pertains to a deceleration of the vehicle that would result if braking torque were applied consistent with the braking request provided by the driver during step 202. The requested deceleration value is preferably calculated by the processor 114 of FIG. 1.

A determination is made as to whether the requested deceleration value calculated in step 204 is greater than a first predetermined deceleration threshold (step 206). In a preferred embodiment, the first predetermined deceleration threshold comprises a value above which it would be desirable to provide different amounts of braking pressure to the first and second axles using dual channel blending. In one preferred embodiment, the first predetermined deceleration threshold comprises an acceptable value of deceleration for a single axle. The first predetermined deceleration threshold may vary depending on the type of vehicle. In one exemplary embodiment, the first predetermined deceleration threshold is in the range of 0.15 g through 0.25 g for certain vehicles. However, this may vary in other embodiments. Also in a preferred embodiment, the first predetermined deceleration threshold is stored in the memory 118 of FIG. 1 as one of the threshold values 122 of FIG. 1. In addition, in a preferred embodiment, the determination of step 206 is made by the processor 114 of FIG. 1.

If it is determined in step 206 that the requested deceleration value is greater than the first predetermined deceleration threshold, then a determination is made as to whether single channel blending is being used in a current iteration of the process 200 (step 208). In a preferred embodiment, this determination is made by the processor 114 of FIG. 1.

If it is determined in step 208 that single channel blending is not being used in a current iteration of the process 200, then braking is applied to the first and second axles using dual channel blending (step 210). Specifically, in a preferred embodiment, during step 210 the braking is applied with a first pressure amount of hydraulic or other braking pressure applied to the first axle 130 of FIG. 1 (the regenerative axle) and with a second pressure amount of hydraulic or other braking pressure applied to the second axle 132 of FIG. 1 (the non-regenerative axle), with the second pressure amount being greater than or equal to the first pressure amount. In a preferred embodiment, braking is applied in step 210 using the dual channel blending until a driver requested brake torque in a subsequent iteration has fallen below a second predetermined deceleration threshold that indicates that the driver has released the brake pedal, as described in greater detail further below in connections with steps 216 and 218.

In addition, during step 210, regenerative braking is preferably provided using the first axle 130 of FIG. 1. In preferred embodiment, the first pressure amount and the second pressure amount are allocated or provided in a manner such that the vehicle is neutrally biased with respect to braking. Thus, the second pressure amount is preferably greater than or equal to the first pressure amount during step 210. In a most preferred embodiment, the second pressure amount applied to the non-regenerative second braking axle 132 of FIG. 1 is greater than the first pressure applied to the regenerative first braking axle 130 of FIG. 1 during step 210. Following step 210, the process preferably returns to the above-referenced step 202, as additional braking requests are received, and the process thereafter preferably continues through various iterations during the braking event.

Conversely, if it is determined in step 208 that single channel blending is being used in a current iteration of the process 200, then braking is applied to the first and second axles using a transition to dual channel blending (step 211). Specifically, in a preferred embodiment, during step 211 the braking is applied with respective first and second pressure amounts to the first and second axles 130, 132 of FIG. 1 such that the difference between the second pressure amount and the first pressure amount gradually increases over this period of time until they reach the levels associated with step 210. In one preferred embodiment, this period of time is equal to approximately 0.5 seconds. However, this may vary in other embodiments. In one preferred embodiment, a linear transition is used. However, this may vary in other embodiments. Once the transition of step 211 is complete, the process proceeds to the above-referenced step 210, as unequal braking pressure is applied to the different axles using dual channel blending.

Returning now to step 206, if it is determined in step 206 that the requested deceleration value is less than or equal to the first predetermined deceleration threshold, then a determination is made as to whether dual channel blending is being used in a current iteration of the process 200 (step 212). In a preferred embodiment, this determination is made by the processor 114 of FIG. 1.

If it is determined in step 212 that dual channel blending is not being used in a current iteration of the process 200, then braking is applied to the first and second axles using single channel blending (step 214). Specifically, in a preferred embodiment, during step 214 the braking is applied with a first pressure amount of hydraulic or other braking pressure applied to the first axle 130 of FIG. 1 (the regenerative axle) and with a second pressure amount of hydraulic or other braking pressure applied to the second axle 132 of FIG. 1 (the non-regenerative axle), with the second pressure amount being equal to the first pressure amount.

In addition, during step 214, regenerative braking is also preferably provided using the first axle 130 of FIG. 1. In a most preferred embodiment, the first pressure amount and the second pressure amount are equal during step 214 irrespective of the amount of regenerative braking on the first axle. Following step 214, the process preferably returns to the above-referenced step 202, as additional braking requests are received, and the process thereafter preferably continues through various iterations during the braking event.

Conversely, if it is determined in step 212 that dual channel blending is being used in a current iteration of the process 200, then a determination is made as to whether the requested deceleration value is less than a second predetermined deceleration threshold (step 216). In a preferred embodiment, the second predetermined deceleration threshold comprises a value such that, when the requested deceleration value is less than the second predetermined deceleration threshold, this indicates that the driver has released the brake pedal. Also in a preferred embodiment, the second predetermined deceleration threshold is stored in the memory 118 of FIG. 1 as one of the threshold values 122 of FIG. 1. In addition, in a preferred embodiment, the determination of step 216 is made by the processor 114 of FIG. 1.

If it is determined in step 216 that the requested deceleration value is greater than or equal to the second predetermined deceleration threshold, then the process returns to the above-referenced step 210, and unequal braking pressure is applied using dual channel blending. The process then returns to step 202, as described above, as additional braking requests are received. In a preferred embodiment, the braking continues in this manner using dual channel blending until there is a determination in a subsequent iteration of step 216 that the requested deceleration value is less than the second predetermined deceleration threshold.

Once it is determined in an iteration of step 216 that the requested deceleration value is less than the second predetermined deceleration threshold, braking is then applied to the first and second axles using a transition to single channel blending (step 218). Specifically, in a preferred embodiment, during step 218 the braking is applied with respective first and second pressure amounts to the first and second axles 130, 132 of FIG. 1 such that the difference between the second pressure amount and the first pressure amount gradually decreases over this period of time until they reach the levels associated with step 214. In one preferred embodiment, this period of time is equal to approximately 0.5 seconds. However, this may vary in other embodiments. In one preferred embodiment, a linear transition is used. However, this may vary in other embodiments. Once the transition of step 218 is complete, the process proceeds to the above-referenced step 214, as braking pressure is applied to the different axles using single channel blending.

The process 200 thereby provides apportionment of braking pressure to different axles of the vehicle. Specifically, in accordance with a preferred embodiment, an equal apportionment of braking pressure is generally provided to the first and second axles 130, 132 of FIG. 1 using single channel blending when the requested deceleration value is less than or equal to the first predetermined deceleration threshold (step 214). Additionally, an unequal apportionment of braking pressure is generally provided to the first and second axles 130, 132 of FIG. 1 using dual channel blending when the requested deceleration value is less than or equal to the first predetermined deceleration threshold (step 210). A smooth transition is provided from the single channel blending of step 214 to the dual channel blending of step 210 when the requested deceleration value is greater than the predetermined deceleration threshold and single channel blending is being used in a most recent iteration (step 211). In addition, a smooth transition is provided from the dual channel blending of step 210 to the single channel blending of step 214 when the requested deceleration value is less than or equal to the first predetermined deceleration threshold, dual channel blending is being used in a most recent iteration, and the requested deceleration value is less than the second predetermined deceleration threshold (step 218). As a result, the process 200 of FIG. 2 provides reduced inconsistencies and non-linearities that might otherwise develop from pressure changes for the braking system, and provides an improved experience for the driver of the vehicle.

Turning now to FIG. 3, a graphical representation 300 is provided of various parameters pertaining to the brake controller 104 of FIG. 1 and the process 200 of FIG. 2 for an exemplary scenario in which the vehicle is being operated, in accordance with an exemplary embodiment of the present invention. Specifically, the graphical representation 300 of FIG. 1 depicts a requested braking torque 302 parameter, a front braking pressure 304 parameter, a rear braking pressure 306 parameter, a boost pressure 308 parameter, and vehicle speed 310 parameter.

The requested braking torque 302 corresponds to the braking requests of step 202 of the process 200 of FIG. 2. The front braking pressure 304 preferably corresponds to the amount of braking pressure applied to the second braking axle 132 of FIG. 1 (preferably a front, non-regenerative braking axle), and as referenced in FIG. 2 as the second pressure amount and applied during steps 210, 211, 214, and 218 of the process 200 of FIG. 2. The rear braking pressure 306 preferably corresponds to the amount of braking pressure applied to the first braking axle 130 of FIG. 1 (preferably a rear, regenerative braking axle), and as referenced in FIG. 2 as the first pressure amount and applied during steps 210, 211, 214, and 218 of the process 200 of FIG. 2. The boost pressure 308 preferably corresponds to an overall boost pressure of the braking system 100 of FIG. 1 and, specifically, of the axles 130, 132 as combined in the braking system 100 of FIG. 1. The vehicle speed 310 comprises a speed of the vehicle as a result of implementing the requested deceleration value of the vehicle of step 204 and the braking pressure as applied during steps 210, 211, 214, and 218 of the process 200 of FIG. 2.

As shown in FIG. 3, once the vehicle speed 310 falls below a certain threshold (namely, 5.5 m/s in the depicted embodiment and under the exemplary conditions of FIG. 3) at point 312 of FIG. 3 (preferably corresponding to the requested deceleration value increasing beyond the first predetermined deceleration threshold in step 206 of the process 200 of FIG. 2), the braking pressure requests to both the first and second axles 130, 132 of FIG. 1 are ramped up thereafter. Specifically, the front braking pressure 304 and the rear braking pressure 306 both increase together after a corresponding point 314 of FIG. 3 (preferably corresponding to steps 210 and 211 of the process 200 of FIG. 2, after the requested deceleration value has increased above the first predetermined deceleration threshold). Subsequently, the front braking pressure 304 and the rear braking pressure 306 both decrease after a corresponding point 316 of FIG. 3 (preferably corresponding to steps 214 and 218 of the process 200 of FIG. 2, after the requested deceleration value has subsequently decreased below the second predetermined deceleration threshold).

Also as shown in FIG. 3, the front braking pressure 304 and the rear braking pressure 306 are preferably nearly equal to one another during most of the exemplary braking event depicted in FIG. 3. Also as depicted in FIG. 3, the front braking pressure 304 and the rear braking pressure 306 are also preferably equal to the boost pressure 308 during most of the braking event of FIG. 3. Accordingly, a smooth driving experience with consistent and substantially linear deceleration is provided for the driver of the vehicle in accordance with an exemplary embodiment.

Accordingly, improved methods and systems are provided for controlling braking of a vehicle with multiple axles. The improved methods and systems adjust the apportionment of braking pressure between the different axles depending on the values of a deceleration value of the vehicle. Specifically, single channel blending is used generally when a requested deceleration value for the vehicle is less than or equal to a first predetermined deceleration threshold. Dual channel blending is used generally when the requested deceleration value for the vehicle is greater than the first predetermined deceleration. A transition from single channel blending to dual channel blending is provided when the requested deceleration value for the vehicle is greater than the first predetermined deceleration threshold and provided further that single channel blending is being used in the most recent iteration. In addition, a transition from dual channel blending to single channel blending is provided when the requested deceleration value for the vehicle is less than or equal to the first predetermined deceleration threshold, dual channel blending is being used in the most recent iteration, and the requested deceleration value for the vehicle has fallen below the second predetermined deceleration threshold (i.e. when the driver has released the brake pedal). As a result, a more consistent and linear deceleration and an improved driving experience is provided in accordance with exemplary preferred embodiments of the present invention.

It will be appreciated that the disclosed methods and systems may vary from those depicted in the Figures and described herein. For example, as mentioned above, the brake controller 104 of FIG. 1 may be disposed in whole or in part in any one or more of a number of different vehicle units, devices, and/or systems. In addition, it will be appreciated that certain steps of the process 200 may vary from those depicted in FIG. 2 and/or described herein in connection therewith. It will similarly be appreciated that certain steps of the process 200 may occur simultaneously or in a different order than that depicted in FIG. 2 and/or described herein in connection therewith. It will similarly be appreciated that the disclosed methods and systems may be implemented and/or utilized in connection with any number of different types of automobiles, sedans, sport utility vehicles, trucks, and/or any of a number of other different types of vehicles, and in controlling any one or more of a number of different types of vehicle infotainment systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method for controlling braking of a vehicle having a first axle and a second axle, the method comprising the steps of:
obtaining a deceleration value pertaining to an input from a driver of the vehicle;
braking the first axle with a first pressure;
braking the second axle with a second pressure that is substantially equal to the first pressure if the deceleration value has not exceeded a predetermined threshold; and
braking the second axle with a third pressure that is greater than the first pressure if the deceleration value has exceeded the predetermined threshold.

2. The method of claim 1, wherein the step of braking the second axle with the third pressure further comprises the step of:
braking the second axle with the third pressure if the deceleration value has exceeded the predetermined threshold, and provided further that the deceleration value has not subsequently been less than a second predetermined threshold.

3. The method of claim 2, further comprising the step of:
braking the second axle with a fourth pressure that is substantially equal to the first pressure if the deceleration value has exceeded the predetermined threshold and has subsequently been less than the second predetermined threshold.

4. The method of claim 1, further comprising the steps of:
obtaining a request corresponding to a requested braking torque from the driver; and
determining the deceleration value based on the requested braking torque.

5. The method of claim 4, wherein the deceleration value comprises a measure of a requested deceleration of the vehicle.

6. The method of claim 1, wherein
the first axle is a regenerative braking axle; and
the second axle is a non-regenerative braking axle.

7. A method for controlling braking of a vehicle having a regenerative braking axle and a non-regenerative braking axle, the method comprising the steps of:
obtaining a deceleration value pertaining to an input from a driver of the vehicle;
braking the regenerative braking axle and the non-regenerative braking axle using single channel blending provided that the deceleration value is less than or equal to a predetermined threshold; and
braking the regenerative braking axle and the non-regenerative braking axle using dual channel blending if the deceleration value is greater than the predetermined threshold.

8. The method of claim 7, further comprising the step of:
transitioning from the single channel blending to the dual channel blending, if the deceleration value is greater than the predetermined threshold and single channel blending is being used.

9. The method of claim 7, further comprising the step of:
transitioning from the dual channel blending to the single channel blending, if each of the following conditions is satisfied:
the deceleration value is less than the predetermined threshold;
dual channel blending is being used; and
the deceleration value is less than a second predetermined threshold.

10. The method of claim 7, further comprising the step of:
braking the regenerative braking axle and the non-regenerative braking axles with at least substantially equal pressures provided that the deceleration value is less than or equal to the predetermined threshold.

11. The method of claim 10, further comprising the step of:
braking the non-regenerative braking axle with a first pressure and the regenerative braking axle with a second pressure, less than the first pressure, if the deceleration value is greater than the predetermined threshold.

12. The method of claim 7, further comprising the steps of:
obtaining a request corresponding to a requested braking torque from the driver; and
determining the deceleration value based on the requested braking torque.

13. The method of claim 12, wherein the deceleration value comprises a measure of a requested deceleration of the vehicle.

14. A system for controlling braking of a vehicle having a regenerative braking axle and a non-regenerative braking axle, the system comprising:
a sensor configured to detect a request corresponding to a requested braking torque; and
a processor coupled to the sensor and configured to facilitate:
determining a deceleration pertaining to the vehicle based on the requested braking torque;
braking the regenerative braking axle and the non-regenerative braking axle using single channel blending provided that the deceleration value is less than or equal to a predetermined threshold; and
braking the regenerative braking axle and the non-regenerative braking axle using dual channel blending if the deceleration value is greater than the predetermined threshold.

15. The system of claim 14, wherein the deceleration value comprises a measure of a requested deceleration of the vehicle.

16. The system of claim 14, wherein the processor is further configured to facilitate:
transitioning from the single channel blending to the dual channel blending, if the deceleration value is greater than the predetermined threshold and single channel blending is being used.

17. The system of claim 14, wherein the processor is further configured to at least facilitate transitioning from the dual channel blending to the single channel blending, if each of the following conditions is satisfied:
the deceleration value is less than the predetermined threshold;
dual channel blending is being used; and
the deceleration value is less than a second predetermined threshold.

18. The system of claim 14, wherein the processor is further configured to facilitate:
braking the regenerative braking axle and the non-regenerative braking axles with at least substantially equal pressures provided that the deceleration value is less than or equal to the predetermined threshold.

19. The system of claim 18, wherein the processor is further configured to facilitate:
braking the non-regenerative braking axle with a first pressure and the regenerative braking axles with a second pressure, less than the first pressure, if the deceleration value is greater than the predetermined threshold.

20. The system of claim 14, further comprising:
a memory configured to store the predetermined threshold.
